(19) United States
(12) Patent Application Publication
(10) Pub. No.: US 2014/0040444 A1
(43) Pub. Date: Feb. 6, 2014

(54) INITIAL CONFIGURATION METHOD OF APPARATUS AND APPARATUS INCLUDING INITIAL CONFIGURATION FUNCTION

(71) Applicant: Electronics and Telecommunications Research Institute, Daejeon (KR)

(72) Inventors: Eun Seo LEE, Daejeon (KR); Kwang Il LEE, Daejeon (KR); Jun Hee PARK, Daejeon (KR)

(73) Assignee: Electronics and Telecommunications Research Institute, Daejeon (KR)

(21) Appl. No.: 13/956,085

(22) Filed: Jul. 31, 2013

(30) Foreign Application Priority Data
Jul. 31, 2012 (KR) 10-2012-0083920
Jul. 1, 2013 (KR) 10-2013-0076383

(51) Int. Cl. H04L 12/24

(52) U.S. Cl. CPC H04L 41/0806
USPC 709/222

(57) ABSTRACT

An initial configuration method of an apparatus and an apparatus of an initial configuration function are provided. The initial configuration method of the apparatus includes performing a setting for connecting to a network based on information provided from a terminal in which a communication channel with the apparatus is formed; and connecting the apparatus to the network and performing a process of registering the apparatus to a management server connected to the network. Accordingly, the initial configuration of the apparatus may be performed without user intervention.

### CLAIM FOR PRIORITY

This application claims priority to Korean Patent Application No. 10-2012-0083920 filed on Jul. 31, 2012 and No. 10-2013-0076383 filed on Jul. 1, 2013 in the Korean Intellectual Property Office (KIPO), the entire contents of which are hereby incorporated by reference.

### BACKGROUND

1. Technical Field

Example embodiments of the present invention relate in general to initial configuration technology and more specifically to an initial configuration method of an apparatus and an apparatus including an initial configuration function which can minimize user intervention.

2. Related Art

Cloud computing is recognized as a new paradigm capable of changing a market economy. Thus, technologies and services combining various types of clouds are being commercialized in home environments as well. Homes are the biggest market of fusion industries mixing various fields such as communications, broadcasting, home appliances, construction, content, robotics, and so on, and is anticipated as a starting point of realization of ubiquitous service.

Currently, home network industries are rapidly changing to smart home industries in which information home appliances and major home appliances are becoming intelligent and networked along with the proliferation of smart phones, smart televisions, etc.

A smart home cloud is technology in which the smart home and the cloud are mixed. This includes a cloud-based N-screen service, a cloud-based home control/management service, a cloud-based green home service, a cloud-based home care service, and so on, in cloud-based smart home services

The cloud-based N-screen service is a service of providing terminal and data management, synchronization, etc. based on a cloud by constructing a media cloud and selectively using various terminals according to situations in the home.

The cloud-based home control/management service is a service of integrally managing and controlling networks, appliances, services, etc., that configure smart home environments in a virtual space based on a cloud.

The cloud-based green home service is a service of providing home energy management for effectively using energy by collecting data through terminals in the home based on a cloud and analyzing the collected data.

The cloud-based home care service is a service of providing optimized and personalized health management by automatically collecting information related to actions or health of family members using sensors of cloud-associated terminals, transmitting the related information to a service center to continuously monitor health conditions, and allowing emergencies to be dealt with.

Meanwhile, recently, in order to support the cloud-based smart home service as described above, as home appliances are connected to a cloud server through the Internet by adding a networking function to conventional single function type home appliances, smart home appliances on which users confirm statuses of and execute wanted functions remotely and which can provide various additional services to the users have been commercialized.

For example, a health care appliance manufacturer provides a scale having a wireless-fidelity (Wi-Fi) function embedded therein to allow connection to a network, and a service when a user weighs him or herself using the scale in which the scale automatically uploads the weight to a cloud server, the cloud server processes the weight to provide it to the user's smart phone, and the user can easily identify changes in his or her weight and body fat using the smart phone.

As described above, the cloud-based smart home services presuppose that various information home appliances are connected via a network. Accordingly, in order to use the smart home services, after a user buys an apparatus, the user has to connect the apparatus to the network, and perform an initialization process in which the apparatus and service are registered in a corresponding server.

However, since the initialization process of current home appliances is complicated, most users which are not accustomed to the use of home appliances have difficulty connecting the home appliances to the network and registering with the corresponding server. Further, due to the difficulty, commercialization of the home appliances supporting the smart home services and proliferation of the services is stagnating.

### SUMMARY

Accordingly, example embodiments of the present invention are provided to substantially obviate one or more problems due to limitations and disadvantages of the related art.

Example embodiments of the present invention provide an initial configuration method of an apparatus for easily performing an initial configuration of an apparatus.

Example embodiments of the present invention also provide an apparatus including an initial configuration function for minimizing user intervention.

In some example embodiments, a initial configuration method of an apparatus performed in the apparatus, the method includes: performing a setting for connecting the apparatus to a network based on information provided from a terminal in which a communication channel with the apparatus is formed; and connecting the apparatus to the network and performing a process of registering the apparatus to a management server connected to the network.

Before the performing of the setting for connecting the apparatus to the network, the method may further include: forming an exclusive communication channel with the terminal; receiving a message instructing the setting of the apparatus from the terminal via the exclusive communication channel; and transmitting an application for a configuration of the apparatus to the terminal in response to the received message.

The performing of the setting for connecting the apparatus to the network may include performing the setting for connecting the apparatus to an Internet protocol (IP)-based network.

The performing of the setting for connecting the apparatus to the network may include: receiving network setting information for connecting the apparatus to an access point or a network sharing device in a home from the terminal; and performing the setting for connecting the network using the network setting information.

Before the connecting of the apparatus to the network and performing of the process of registering the apparatus to a management server connected to the network, the method may further include: releasing the communication channel formed between the apparatus and the terminal

The connecting of the apparatus to the network and performing of the process of registering the apparatus to a management server connected to the network may include: transmitting a message instructing apparatus registration to the management server via the network; receiving a message indicating completion of the apparatus registration from the management server; and transmitting the message indicating the completion of the apparatus registration to the terminal

The connecting of the apparatus to the network and performing of the process of registering the apparatus to a management server connected to the network may include: connecting the apparatus to an access point or a network sharing device; connecting the apparatus to the access point or the network routing apparatus and connecting to the Internet; and connecting the apparatus to the management server connected to the Internet.

The transmitting of the message indicating the completion of the apparatus registration to the terminal may include transmitting the message indicating the completion of the apparatus registration via the access point or the network sharing device.

The initial configuration method of the apparatus may include communicating predefined messages with the terminal and the management server in the performing of the setting for connecting the apparatus to the network and the performing of the process of registering the apparatus, and the message may include a header including an operational code indicating a function for the initial configuration of the apparatus, and a payload including information for the initial configuration of the apparatus.

The operational code may instruct at least one function among device registration, service registration, apparatus control, an event process, an event subscription, and a file transaction.

In other example embodiments, an initial configuration method of an apparatus in a terminal includes: transmitting information for registration of the apparatus to the apparatus using a communication channel formed between the terminal and the apparatus; receiving a message indicating that the apparatus is registered to a management server from the apparatus; and transmitting a message requesting service registration to the management server.

Before the transmitting of the information for the registration of the apparatus to the apparatus, the method may further include: forming an exclusive communication channel with the terminal; transmitting a message instructing the initial configuration of the apparatus via the exclusive communication channel to the apparatus; receiving an application for controlling the initial configuration of the apparatus from the apparatus; executing the received application; and performing a process for transmitting the information for the initial registration of the apparatus to the apparatus by the executed application.

Before the transmitting of the information for the registration of the apparatus to the apparatus, the method may further include: connecting to the management server based on information obtained by photographing a code displayed on the apparatus; downloading an application for controlling the initial configuration of the apparatus from the management server, and executing the downloaded application; and transmitting the information of the initial configuration of the apparatus to the apparatus using the communication channel formed between the terminal and the apparatus by the executed application.

In still other example embodiments, an apparatus includes: a network interface configured to support an Internet protocol (IP)-based network connection and short-distance wireless communication; a message manager configured to analyze a received message from the network interface, transmit a message based on the analyzed result, and create a message corresponding to a provided instruction; and a function manager configured to perform a process for an initial configuration corresponding to a provided message from the message manager, or provide an instruction for the initial configuration.

The message manager may create a message including a header and a payload, and the header may include an operational code including instruction information for the initial configuration of the apparatus.

The operational code may instruct at least one function among device registration, service registration, apparatus control, an event process, an event subscription, and a file transaction.

The function manager may include: a manager module configured to perform a control related to the initial configuration of the apparatus; a file manager module configured to manage a file related to the initial configuration of the apparatus; a configuration manager configured to perform a process for creating the communication channel between the network interface and other apparatuses; and a registration manager configured to perform registration of the apparatus.

### BRIEF DESCRIPTION OF DRAWINGS

Example embodiments of the present invention will become more apparent by describing in detail example embodiments of the present invention with reference to the accompanying drawings, in which:

FIG. 1 is a conceptual diagram explaining a connection relationship and a service provision method between apparatuses established in a home;

FIG. 2 is a conceptual diagram explaining an initial configuration process of an apparatus without a display means;

FIG. 3 is a conceptual diagram explaining an initial configuration method of an apparatus according to an embodiment of the inventive concept;

FIG. 4 is a flowchart illustrating an initial configuration method of an apparatus according to an embodiment of the inventive concept;

FIGS. 5A, 5B and 5C are a conceptual diagram illustrating an initial configuration process of an apparatus according to an embodiment of the inventive concept;

FIG. 6 is a flowchart illustrating an example of an initial configuration method performed in an apparatus according to an embodiment of the inventive concept;

FIG. 7 is a flowchart illustrating one example of an initial configuration method performed in a smart terminal according to an embodiment of the inventive concept;

FIG. 8 is a flowchart illustrating another example of an initial configuration method performed in a smart terminal according to another embodiment of the inventive concept;

FIG. 9 is a conceptual diagram illustrating a system structure of an apparatus including an initial configuration function according to an embodiment of the inventive concept;

FIG. 10 illustrates a message structure used in an initial configuration method according to an embodiment of the inventive concept;

FIG. 11 illustrates a header format among the message structure of FIG. 10 in detail;

FIG. 12 illustrates detailed content of an operational code of FIG. 11.

### DESCRIPTION OF EXAMPLE EMBODIMENTS

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.). The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

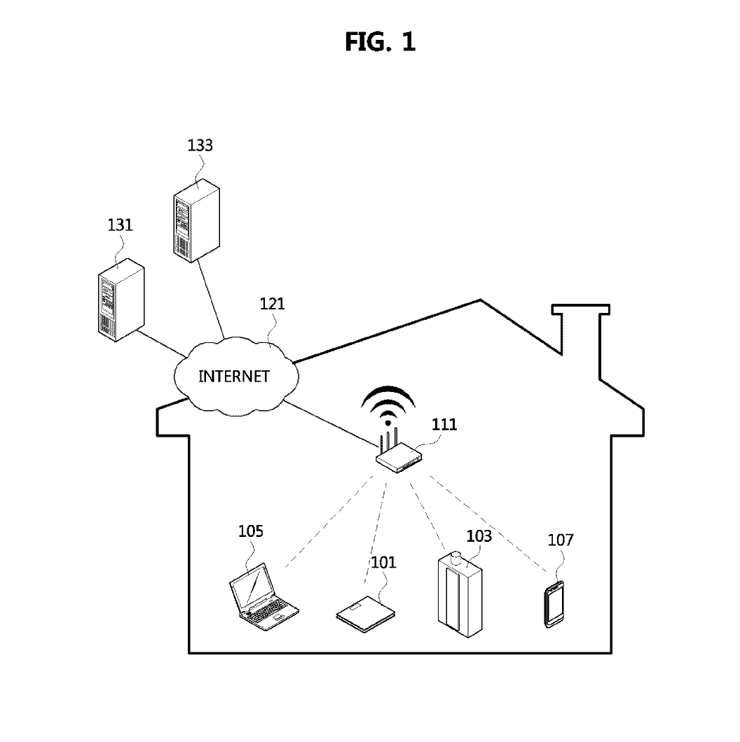

FIG. 1 is a conceptual diagram explaining a connection relationship and a service provision method between apparatuses established in a home.

As shown in FIG. 1, various apparatuses 101 and 103 within the home or a specific area may connect to an access point (AP) 111 or a network sharing device together with a personal computer 105 or a smart terminal 107, etc., connect to the Internet 121 through the access point 111 or the network sharing device, and connect to external management servers 131 and 133 for managing the apparatuses 101 and 103 through the Internet 121, respectively. Therefore, the apparatuses 101 and 103 may be respectively associated with the external management servers 131 and 133 to provide various services corresponding to each of the apparatuses 101 and 103 through the smart terminal 107.

For example, a first apparatus 101 shown in FIG. 1 may be associated with a first server 131 to provide a service associated with the first apparatus 101, and a second apparatus 103 may be associated with a second server 133 to provide a service associated with the second apparatus 103. Otherwise, if manufacturers of the first and second apparatuses 101 and 103 are the same, the first and second apparatuses 101 and 103 may provide a service by associating with any one of the first server 131 and the second server 133.

Here, each of the apparatuses 101 and 103 may be a home appliance such as a refrigerator, a washing machine, a robotic cleaner, a scale, an oven, a television, and so on. Further, each of the apparatuses 101 and 103 may connect to the access point 111 using a wireless or wired interface which can connect to the Internet based on an IP protocol such as wireless-fidelity (Wi-Fi), Ethernet, etc., and connect to the Internet 121 via the access point 111.

In order to use a service associated with each of the apparatuses 101 and 103, a user may connect to a specific server, download an application, install the application in the smart terminal 107, and use a service associated with each of the apparatuses 101 and 103 using the application installed in the smart phone 107.

On the other hand, services provided in an environment shown in FIG. 1 have already been commercialized and used in real life. For example, a service in which, when an ultrasonic moving picture of a fetus is filmed via an ultrasonic apparatus in an obstetrics and gynecology clinic, the moving picture may be uploaded to a cloud server, and after a mother and her family connect to the cloud server and complete user registration, they may see the moving picture of the fetus via a personal computer and a smart phone anywhere and at any time is being provided.

According to commercialization of services as described above, apparatus manufacturers are develop devices which can connect to a network, and putting much effort into providing users with various services which are different from those of conventional apparatuses. This may be an important means to distinguish one apparatus manufacturer from a rival manufacturer.

Meanwhile, in a service provision environment as shown in FIG. 1, since the apparatus should be connected to the network and registered to a corresponding management server via the network, when a user purchases the apparatus and installs it in his or her home, the user may connect to the network, and register the apparatus to the corresponding server via the network.

However, users who are not accustomed to electronic appliances or information and communication technology may have difficulty processing an initial configuration process of connecting the apparatus to the network, and registering the apparatus, etc.

Particularly, if there is no display means in the apparatus, since not only can the user not directly identify a setting status and process of the apparatus but neither can the apparatus display a menu and help, etc. for an initial configuration of the apparatus, the user may have more difficulty for the initial configuration of the apparatus.

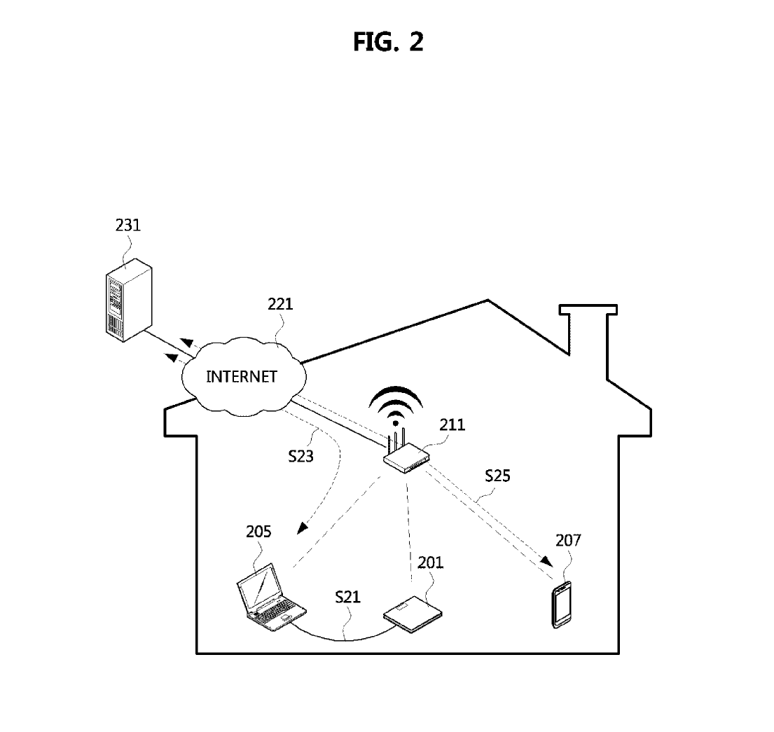

FIG. 2 is a conceptual diagram explaining an initial configuration process of an apparatus without a display means.

Referring to FIG. 2, to begin with, a user may connect an apparatus 201 without a display means to a personal computer (PC) 205 using a communication interface such as a universal serial bus (USB), etc. (S21).

After this, the user may connect to a management server 231 of an apparatus manufacturer using the PC 205, search for an installation management program for a configuration of the apparatus 201, and download it to the PC 205. Users who are not accustomed to electronic appliances and information and communication technology may have difficulty performing these processes.

After this, the user may execute the downloaded installation management program, and perform actions required when the executed installation management program performs a process for the configuration of the apparatus 201. In this process, the installation management program executed in the PC 205 may communicate with the apparatus 201 via the USB to perform a setting for connecting the apparatus 201 to the access point 211 in the home, and connect to the external management server 231 connected to the Internet 221 via the access point 211 to register the apparatus 201 to the external management server 231 (S23).

If the initial configuration of the apparatus is completed, the user may connect to the external management server 231 using a smart terminal 207, search for an application related to the apparatus for which the initial configuration is completed, and download the searched corresponding application to the smart terminal 207. After this, the user may execute the downloaded application, and register the user and/or a service (S25).

Through the above described process, if the initial configuration of the apparatus 201 and the user (or the service) registration are completed, the user may use the service associated with the apparatus 201.

However, the initial configuration process of the apparatus as shown in FIG. 2 may be very difficult and inconvenient to users who are not accustomed to use of electronic appliances or network setting.

As the inventive concept is to solve the above described problem, in an environment in which an apparatus installed in a home or a specific area may connect to a network to connect an external management server, etc., and be associated with the external management server to provide various additional services to a user, the inventive concept may provide a method of easily performing an initial configuration of an apparatus without knowledge or special efforts for the initial configuration of the apparatus, and an apparatus including a function of the initial configuration.

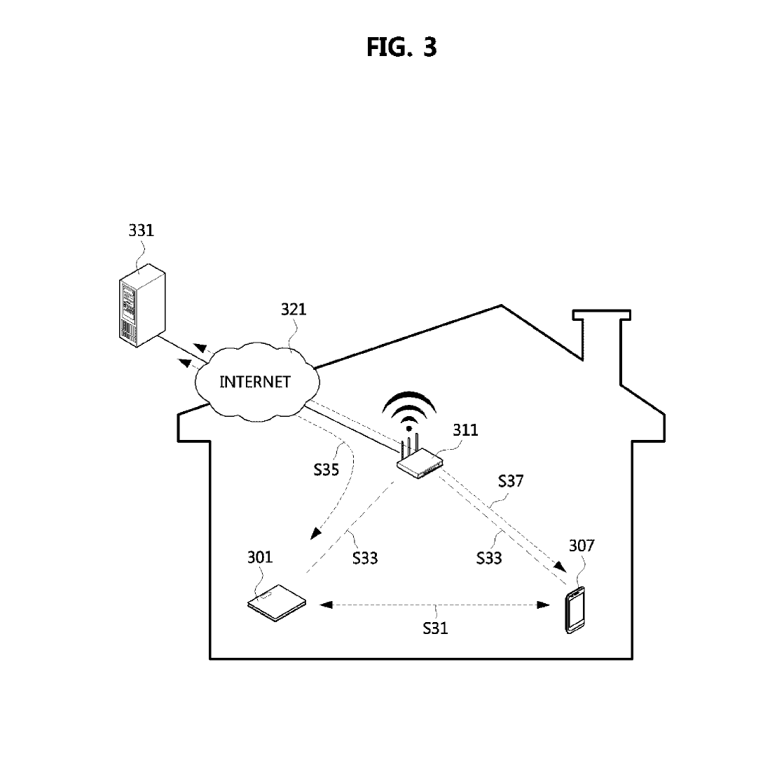

FIG. 3 is a conceptual diagram explaining an initial configuration method of an apparatus according to an embodiment of the inventive concept.

FIG. 3 conceptually illustrates an initial configuration process of an apparatus 301 installed in a home, in an environment in which an access point 311 is installed to connect to the Internet 321 in the home, and a management server 331 of the apparatus 301 for an initial configuration is connected to the Internet 321.

Referring to FIG. 3, the initial configuration process of the apparatus may be started using a predefined communication method, or a QR code (S31).

For example, the apparatus 301 and a smart terminal 307 may form an intrinsic communication channel by constituting an Ad-Hoc network using a short-distance communication method which can communicate files or data through direct communication between adjacent communication apparatuses rather than through an infrastructure of a communication company such as NFC (near field communication), ZigBee, UWB (ultra wideband), Bluetooth, Wi-Fi, P2P, etc. or an additional access point apparatus, and exchange information needed for the initial configuration of the apparatus 301 using the formed network. For this, if power is supplied to the apparatus 301, the apparatus 301 may be configured to automatically broadcast an advertising message to find the smart terminal 307 located around the apparatus 301. Upon receiving the advertising message, the smart terminal 307 may transmit a response message in response to the advertising message to the apparatus 301, and perform a connection process to form the Ad-Hoc network. On the other hand, the smart terminal 307 may broadcast the advertising message, and the apparatus 301 may respond to the advertising message to perform the connection process, and then form the Ad-Hoc network.

Meanwhile, if the apparatus 301 and the smart terminal 307 cannot form a communication channel which can communicate the files or the data, the smart terminal 307 may acquire information needed for the initial configuration of the apparatus 301 from an external management server 331 using the QR code attached to the apparatus 301.

After this, if the apparatus 301 is connected to the Internet 321 via the access point 311, the smart terminal 307 and the apparatus 301 may release the intrinsic communication channel which is already formed, and each of the smart terminal 307 and the apparatus 301 may connect to the access point 311 (S33).

After this, the apparatus 301 may pass through the access point 311 and the Internet 321, and register to the management server 331 using an appointed process and message (S35).

Further, the smart terminal 307 may register a service (or a user) to the management server 331, and then utilize a corresponding service (S37).

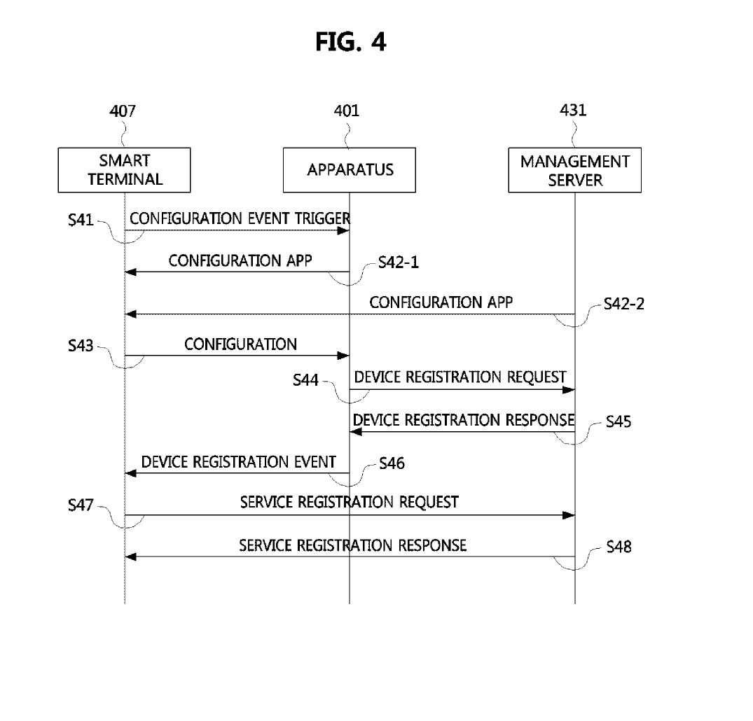

FIG. 4 is a flowchart illustrating an initial configuration method of an apparatus according to an embodiment of the inventive concept. FIG. 4 illustrates a process sequence and messages communicated among a smart terminal 407, an installation object apparatus 401, and a management server 431 located in a remote place for an initial configuration of an apparatus.

Referring to FIG. 4, an exclusive communication channel between the smart terminal 407 and the installation object apparatus 401 may be formed via an appointed communication interface. For example, the smart terminal 407 and the installation object apparatus 401 may form an intrinsic communication channel by forming an Ad-Hoc network via a short-distance communication interface such as NFC, ZigBee, UWB, Bluetooth, Wi-Fi, P2P, etc. For convenience, it will be explained on the assumption that the smart terminal 407 and the installation object apparatus 401 communicate in the NFC method.

A user may start an initialization procedure using the smart terminal 407. Here, the initialization procedure may be started from a process of installing an application for a setting of the installation object apparatus 401 in the smart terminal 407.

In detail, the smart terminal 407 may transmit a configuration event trigger message for instructing the setting of the installation object apparatus 401 to the installation object apparatus 401 (S41). Here, the smart terminal 407 may be configured to transmit the configuration event trigger message in response to an instruction such as a menu operation, etc. of the user, or to automatically transmit the configuration event trigger message if the Ad-Hoc network is formed together with the installation object apparatus 401.

The installation object apparatus 401 may transmit a configuration application for a configuration of the installation object apparatus 401 to the smart terminal 407 in response to the configuration event trigger message received from the smart terminal 407 (S42-1).

That is, in an embodiment of the inventive concept, the installation object apparatus 401 may store an application for the initial configuration, directly transmit the stored application to the smart terminal 407 when the configuration event trigger message for indicating a configuration start of the apparatus is received from the smart terminal 407, and then allow a user to easily perform initialization of the installation object apparatus 401 using the smart terminal 407.

Further, if the installation object apparatus 401 cannot directly provide the application to the smart terminal 407, the smart terminal 407 may be configured to acquire the application needed for a setting of the installation object apparatus 401 using a QR code attached to the installation object apparatus 401. In this case, the user may automatically connect to the management server 431 for providing the application for the setting of the installation object apparatus 401 by photographing the QR code attached outside of the installation object apparatus 401 using a camera included in the smart terminal 407, and then download the application from the management server 431 (S42-2). Here, the QR code may include address information of the management server 431 from which the application for the configuration of the installation object apparatus 401 can be downloaded, information related to the installation object apparatus 401, application information for the configuration of the installation object apparatus 401, and so on, and when the user photographs the QR code, the smart terminal 407 may be configured to extract the information from the QR code, connect to a specific management server 431 using the extracted information, and then automatically download the application (i.e. application file) from the management server 431.

As described above, if the application for the setting of the installation object apparatus 401 is downloaded to the smart terminal 407 using NFC or the QR code, the smart terminal 407 may automatically execute the application.

After this, the application executed in the smart terminal 407 may perform a process for an initial configuration of the installation object apparatus 401 using a pre-appointed protocol and message format (S43). Here, the smart terminal 407 may activate a communication interface included in the installation object apparatus 401 by communicating an instruction and data with the installation object apparatus 401 using an exclusive communication channel formed between the smart terminal 407 and the installation object apparatus 401, and perform network initialization by performing various settings related to a network connection so as to be able to communicate through the activated communication interface. The communication interface included in the installation object apparatus 401 may be a communication interface which is connectable to an IP-based Internet service such as Wi-Fi, etc., and the installation object apparatus 401 may be connected to an access point or a network sharing device installed in the home via the Wi-Fi communication interface, connected to the Internet via the access point or the network sharing device, and set to be connected to the external management server 431.

When the network initialization of the installation object apparatus 401 is completed, each of the smart terminal 407 and the installation object apparatus 401 may release the exclusive communication channel, and connect to the access point.

After this, the installation object apparatus 401 may transmit a device registration request message to the management server 431 using the activated communication interface according to the pre-appointed protocol and message format (S44). Here, the management server 431 connected to the Internet may perform a registration process of the installation object apparatus 401 in response to the device registration request message received from the installation object apparatus 401, and transmit the device registration request message indicating that the registration process is successfully completed to the installation object apparatus 401 according to the pre-appointed protocol and message format (S45).

If the installation object apparatus 401 receives the device registration response message from the management server 431, the installation object apparatus 401 may transmit a device registration event message indicating that the registration of the installation object apparatus 401 is successfully completed using the predefined protocol and message format to the smart terminal 407 (S46). Here, the installation object apparatus 401 may transmit the device registration event message via an activated communication interface such as Wi-Fi, etc. to the smart terminal 407, and if the smart terminal 407 receives the device registration event message from the installation object apparatus 401, the smart terminal 407 may display a message indicating that the registration of the installation object apparatus 401 is completed on a display means.

As described above, if the smart terminal 407 completes the registration of the installation object apparatus 401 and receives the device registration event message, the smart terminal 407 may transmit a service registration request message for requesting registration of a service (or a user) associated with the installation object apparatus 401 using the pre-assigned protocol and message format to the management server 431 (S47). Here, the smart terminal 407 may be configured to transmit the service registration request message in response to manipulation of the user to the management server 431, or automatically transmit the service registration request message to the management server 431 after being triggered in response to reception of the device registration event message.

If the management server 431 receives the service registration request message from the smart terminal 407, the management server 431 may perform a registration process of a service (or a user) in response to the service registration request message, and then transmit a service registration response message indicating that the service registration is successfully completed using the pre-appointed protocol and message format to the smart terminal 407 (S48).

If the smart terminal 407 receives the service registration response message indicating that the service registration is successfully completed, the smart terminal 407 may display a message indicating the completion of the service registration on a display means.

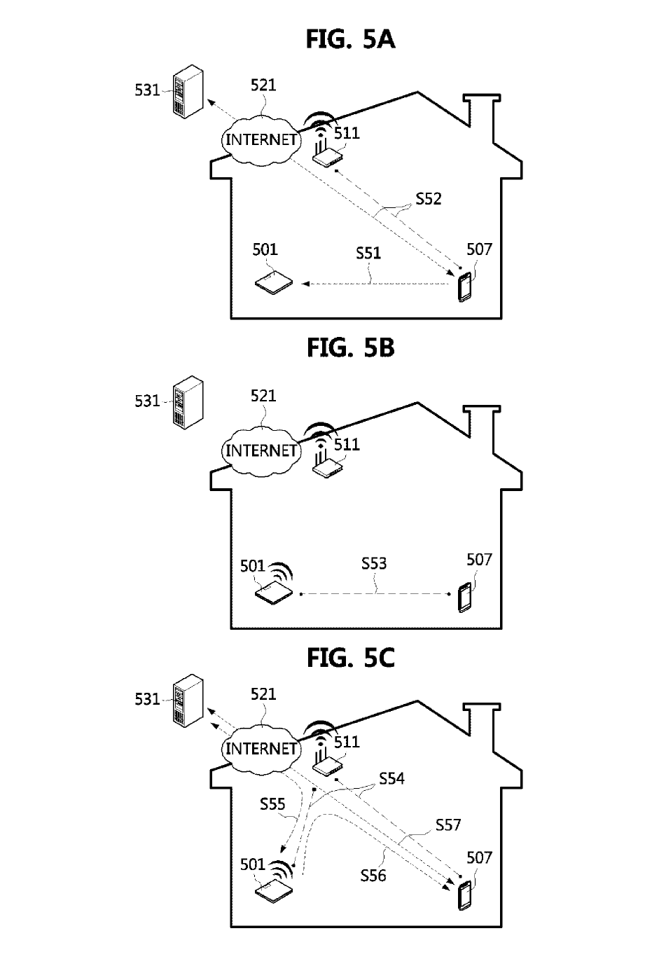

FIGS. 5A, 5B and 5C are a conceptual diagram illustrating an initial configuration process of an apparatus according to an embodiment of the inventive concept.

FIGS. 5A, 5B and 5C illustrates a process in which a smart terminal 507 acquires an application for an initial configuration of an apparatus 501 using a QR code, and performs the initial configuration of the apparatus 501 by executing the application.

To begin with, referring to FIG. 5A, if a user photographs the QR code attached to the apparatus 501 through the smart terminal 507 (S51), the smart terminal 507 may connect to the external management server 531 for managing the apparatus 501 based on information (for example, a uniform resource locator of the external management server 531, an apparatus indicator, an application indicator, etc.) corresponding to the QR code, and download and install the application for a setting of the apparatus 501 (S52). Here, the smart terminal 507 may previously connect to an access point 511, connect to the Internet 521 using the access point 511, and connect to the external management server 531 connected to the Internet 521 through the access point 511.

On the other hand, if a power supply is applied, the apparatus 501 may be set to form an Ad-Hoc network by a predefined service set identifier (SSID).

Referring to FIG. 5B, if the application installed in the smart terminal 507 is executed, the application of the smart terminal 507 may connect to the appointed Ad-Hoc network to form an intrinsic communication channel with the apparatus 501, and perform a process for connecting the apparatus 501 to the access point 511 installed in the home using the formed communication channel (S53). Here, the application of the smart terminal 507 may search for the access point 511 installed in the home, transmit the SSID corresponding to the searched access point 511 to the apparatus 501 via the formed communication channel, and transmit security information (for example, a password) to the apparatus 501 if security is set in the access point 511. At this time, the application of the smart terminal 507 may display a user interface screen for acquiring the security information on the display means, and may transmit the security information input by the user to the apparatus 501.

Further, the application of the smart terminal 507 may transmit information needed for the configuration of the apparatus 501 through the formed channel to the apparatus 501.

A process after this will be explained with reference to FIG. 5C.

If the transmission of the information needed for the procedure and configuration for connecting to the access point 511 in the home is completed, the Ad-Hoc network formed between the smart terminal 507 and the apparatus 501 may be released, and then the exclusive communication channel formed between the smart terminal 507 and the apparatus 501 may be released.

After this, the apparatus 501 may connect to the access point 511 in the home using the set information, and also the smart terminal 507 may connect to the access point 511 (S54).

The apparatus 501 may connect to the access point 511, transmit a device registration request message according to a pre-appointed protocol and message format to the external management server 531 connected to the Internet 521, and successfully receive a device registration response message indicating that the registration of the apparatus 501 is successfully completed from the external management server 531 (S55).

After this, the apparatus 501 may transmit a message indicating that the registration of the apparatus 501 is completed corresponding to the device registration response message received from the external management server 531 to the smart terminal 507 (S56). Here, since both the apparatus 501 and the smart terminal 507 are connected to the access point 511, the apparatus 501 may transmit a message indicating that the registration of the apparatus 501 is completed using the access point 511 to the smart terminal 507.

If the application of the smart terminal 507 receives the device registration completion message from the apparatus 501, the application of the smart terminal 507 may display the device registration completion message using a display means, automatically connect to the external management server 531 according to manipulation of a user or a predetermined method, and perform a registration process of a service (or the user) associated with the apparatus 501 (S57).

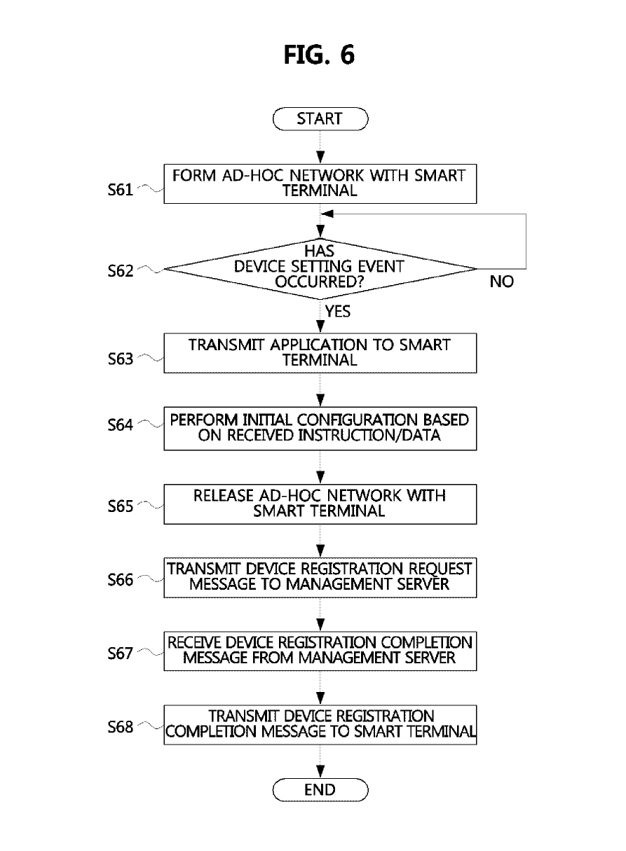

FIG. 6 is a flowchart illustrating an example of an initial configuration method performed in an apparatus according to an embodiment of the inventive concept.

Referring to FIG. 6, when power is supplied, an initial configuration object apparatus, may broadcast the predefined SSID to allow the smart terminal to find the apparatus, and form an intrinsic communication channel with the smart terminal by performing a connection procedure with the smart terminal and configuring an Ad-Hoc network (S61).

After this, the apparatus may determine whether an event instructing an apparatus setting from the smart terminal has occurred via the formed communication channel (S62). Here, in the event instructing the apparatus setting, if an apparatus as shown in FIG. 4 receives a configuration event trigger message from the smart terminal, a decision that an apparatus setting event has occurred may be made.

According to a result of step S62, if a decision that the device setting event has occurred is made, the apparatus may transmit the stored application to the smart terminal via a communication channel formed together with the smart terminal (S63). Here, the application may be installed in the smart terminal to perform a process for an initial configuration of the apparatus by exchanging data with the apparatus.

After this, the apparatus may perform the process for the initial configuration based on an instruction and/or data provided from the smart terminal (S64). That is, the apparatus may perform a setting for connecting to an IP-based network based on the instruction and/or the data provided from the smart terminal Here, the apparatus may activate a communication interface which is connectable to an IP-based Internet service such as Wi-Fi, etc. based on the instruction or the data provide from the smart terminal, and perform network initialization for performing communication via the activated communication interface. For example, the apparatus may connect to the access point installed in the home by performing a setting for connecting to the access point based on SSID information or network security information of a Wi-Fi network (or a wireless LAN) provided from the smart terminal, and connect to the Internet using the access point.

After performing the network initialization as described above, the apparatus may connect to the access point, and release the Ad-Hoc network formed between the apparatus and the smart terminal (S65).

After this, the apparatus may transmit a message requesting device registration to a management server which is connected to the Internet (S66). Here, the apparatus may transmit the message by adding information needed for the device registration such as an apparatus type, an apparatus intrinsic identification number, a network address at which an apparatus is installed, and so on, to the device registration message.

After this, the apparatus may receive a registration response message indicating that the device registration is successfully completed from the management server (S67).

The apparatus receiving the device registration response message may transmit a message (for example, a device registration event message) indicating that the device registration is completed from the smart terminal (S68).

On the other hand, while an example in which an application needed for a configuration of the apparatus is directly transmitted from the apparatus to the smart terminal after the apparatus and the smart terminal form an Ad-Hoc network is explained in FIG. 6, if the apparatus is constituted not to transmit the application to the smart terminal via a communication channel, or the Ad-Hoc network between the apparatus and the smart terminal is not formed, steps S61 to S63 may not be performed, and in this case, the smart terminal may acquire an application needed for the configuration of the apparatus using a QR code attached to the apparatus as described above.

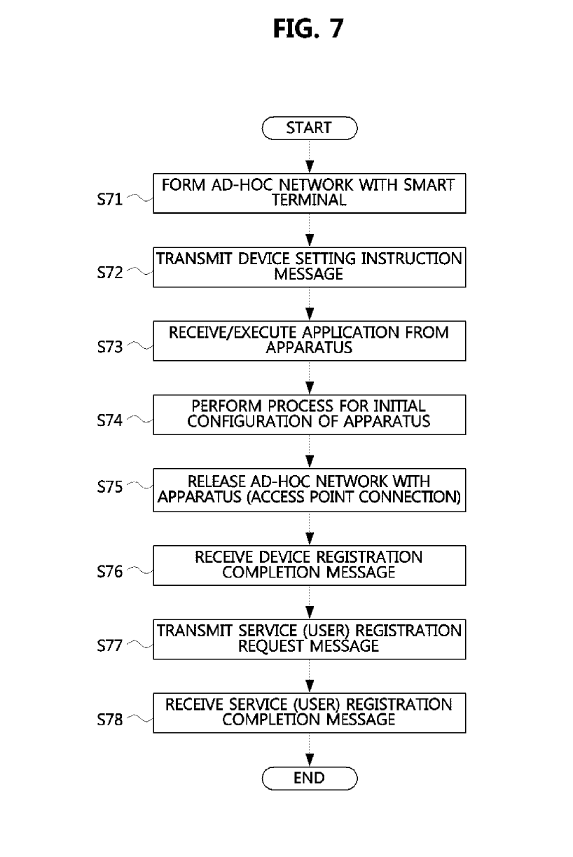

FIG. 7 is a flowchart illustrating one example of an initial configuration method performed in a smart terminal according to an embodiment of the inventive concept. FIG. 7 illustrates an initial configuration process of an apparatus performed in a smart terminal when an Ad-Hoc network is formed between the smart terminal and the apparatus.

Referring to FIG. 7, the smart terminal may form the Ad-Hoc network with the apparatus, and then form an intrinsic communication channel together with the apparatus (S71). Here, a user may execute a specific application installed in the smart terminal, and the specific application executed in the smart terminal may find the apparatus located adjacent thereto and perform a process for forming the Ad-Hoc network together with the apparatus.

After this, the smart terminal may transmit a message instructing an initial configuration to the apparatus via the formed communication channel (S72). Here, the message instructing a setting of the apparatus may be an event triggering message instructing the initial configuration of the apparatus such as the configuration event trigger message as shown in FIG. 4, and may be constituted and transmitted according to a predefined message format and protocol.

The smart terminal may receive an application transmitted from the apparatus in response to the message transmitted as described above, and execute the received application (S73). Here, the application received from the apparatus may perform a process for the initial configuration of the apparatus.

After this, the application executed in the smart terminal may provide an instruction and/or data for the initial configuration of the apparatus to the apparatus via the formed communication channel, and perform a process for the initial configuration of the apparatus (S74). Here, the smart terminal may provide the instruction and/or the data (for example, SSID, password, etc., of the access point) needed for connecting the apparatus to an IP-based network to the apparatus, and the apparatus may activate a communication interface such as Wi-Fi, etc., based on the instruction and/or the data provided from the smart terminal and perform a network initialization for connecting to the access point (or the Internet) in the home via the activated communication interface. Further, the smart terminal may require information needed for the process for the initial configuration of the apparatus to a user via a user interface of the smart terminal, and transmit information provided from the user to the apparatus.

As described above, if the apparatus is able to connect to the access point (or the Internet) in the home through the process for the configuration of the apparatus, the smart terminal may release the Ad-Hoc network with the apparatus, and connect to the access point (S75).

After this, the smart terminal may receive a message indicating registration completion of the apparatus from the apparatus (S76), and transmit a message requesting service (or user) registration in response to the message indicating registration completion of the apparatus to the management server (S77).

After this, if the smart terminal receives a message indicating the service (or the user) registration completion from the management server (S78), the smart terminal may end the process for the initial configuration of the apparatus.

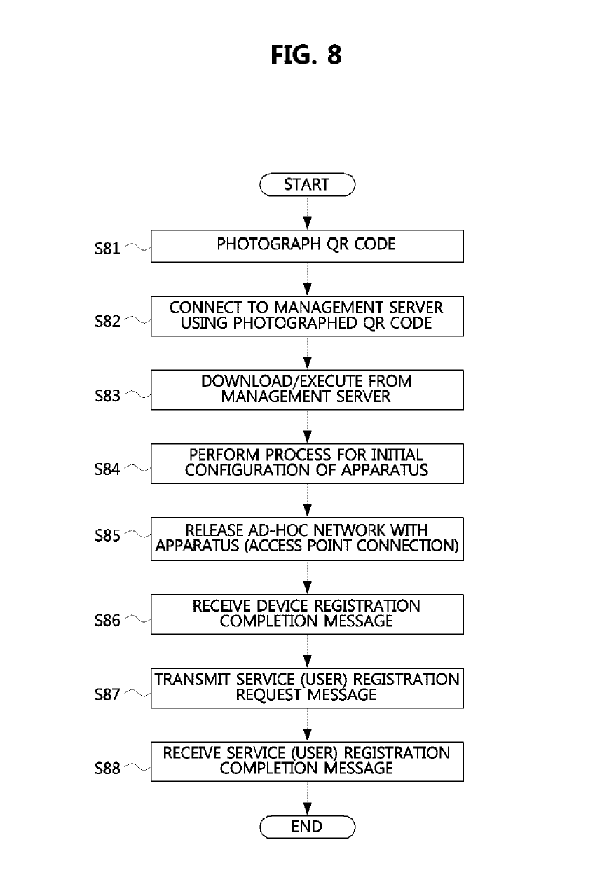

FIG. 8 is a flowchart illustrating another example of an initial configuration method performed in a smart terminal according to another embodiment of the inventive concept. FIG. 8 illustrates an initial configuration process of an apparatus in the case of acquiring an application for the initial configuration of the apparatus using a QR code attached to the apparatus.

Referring to FIG. 8, a smart terminal may photograph the QR code attached to the apparatus according to manipulation of a user (S81).

After this, the smart terminal may acquire information corresponding to the QR code by processing the photographed QR code image, and connect to a management server using the acquired information (S82). Here, the information corresponding to the QR code image acquired by the smart terminal may include address information from which an application for processing the configuration of the apparatus can be downloaded, apparatus information, application information for processing the configuration of the apparatus, and so on.

After this, the smart terminal may download the application for the configuration of the apparatus from the management server, and execute the downloaded application (S83).

Since steps S84 to S88, which are processes after the application is executed in the smart terminal, may be the same processes as steps S74 to S78, a detailed description for these steps will be omitted to avoid repetition.

An apparatus executing an initial configuration function according to an embodiment of the inventive concept as described above will be explained hereinafter.

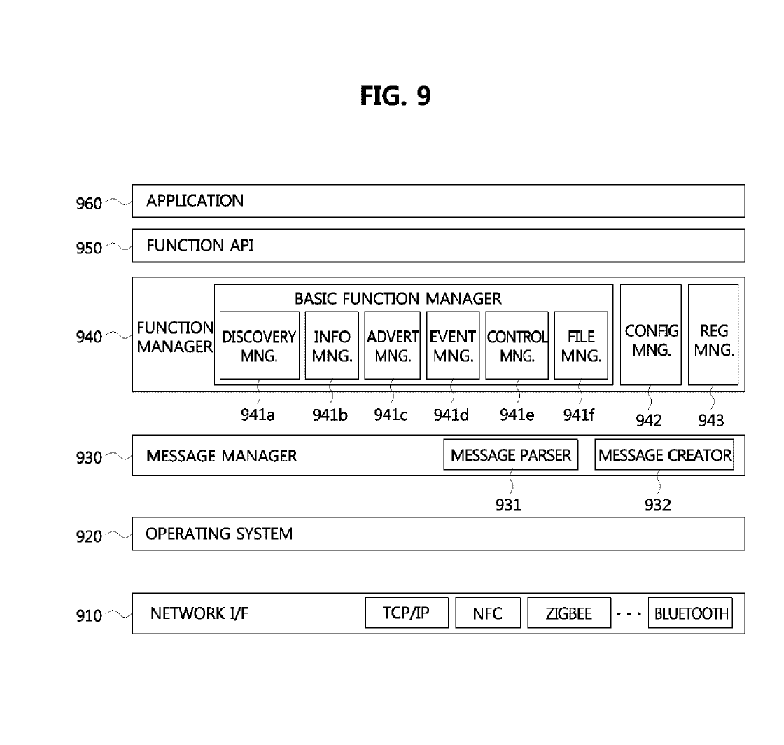

FIG. 9 is a conceptual diagram illustrating a system structure of an apparatus including an initial configuration function according to an embodiment of the inventive concept. FIG. 9 illustrates a system structure which can include an initial configuration object apparatus, a smart terminal and an external management server as an example. For convenience, it will be described hereinafter on the assumption that the system structure is included in the initial configuration object apparatus.

Referring to FIG. 9, the apparatus may have a structure in which a network interface 910, an operating system 920, a message manager 930, a function manager 940, a function API (application program interface) 950, and an application 960 are constituted hierarchically.

The network interface 910 may include at least one among a network interface for a TCP/IP-based Internet connection such as Wi-Fi, etc., and network interfaces for short-distance communication such as an NFC module, a ZigBee module, a UWB module, a Bluetooth module, and so on.

The operating system 920 layer for managing an entire operation may be located on a higher layer of the network interface 910.

The message manager 930 for analyzing and creating various messages needed for an initial configuration of an apparatus may be located on a higher layer of the operating system 920. Here, the message manager 930 may include a message parser 931 for parsing and analyzing a message provided from a lower layer and transmitting to a higher layer according to the analyzed result, and a message creator 932 for configuring a message corresponding to an instruction and data transmitted from the higher layer.

The function manager 940 for processing various information according to a message may be located on a higher layer of the message manager 930. The function manager 940 may include a basic function manager 941 for processing a basic function needed for the initial configuration of the apparatus, a configuration manager 942 for processing a function in which the network interface forms a communication channel together with other apparatuses (for example, a smart terminal, an access point, a management server, etc.), and a registration manager 943 for processing registration of the apparatus and/or a user.

Further, the basic function manager 941 may include a discovery management module 941a processing a function of finding the smart terminal adjacent to the apparatus, a information management module 941b managing information related to the initial configuration of the apparatus, an advertising management module 941c performing a process related to an advertisement, a event management module 941d managing a process of an event, a control management module 941e performing control related to the configuration of the apparatus, and a file management module 941f managing a file related to the initial configuration of the apparatus.

The function API 950 for associating each of functions included in the function manager 940 with an application located on the highest layer may be located on a higher layer of the function manager 940.

Further, the application 960 layer may be located on a higher layer of the function API 950.

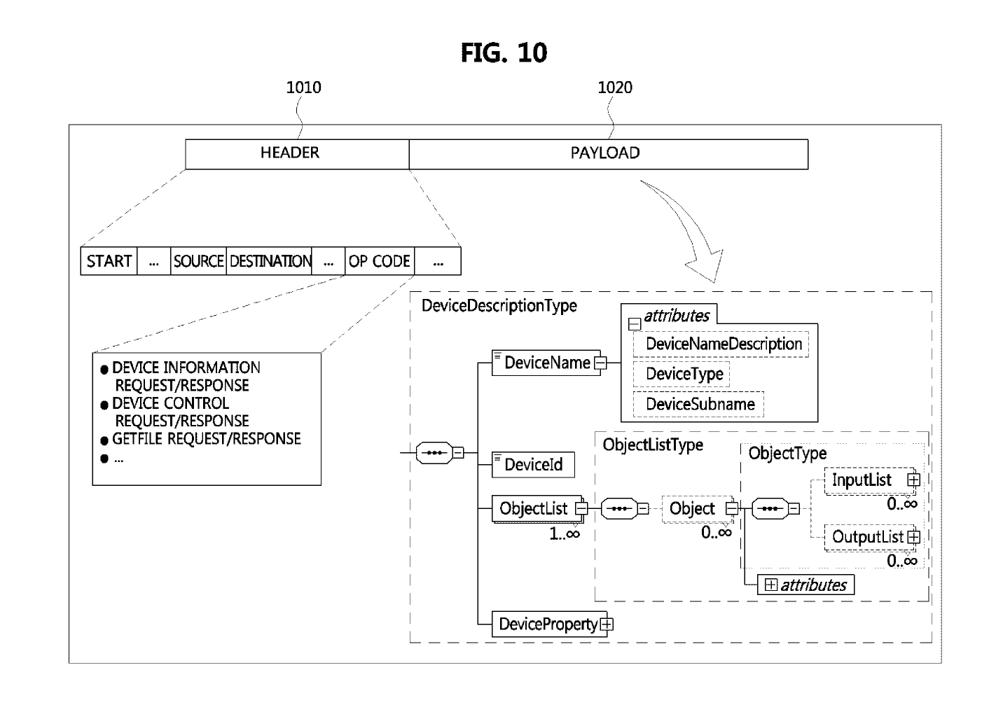

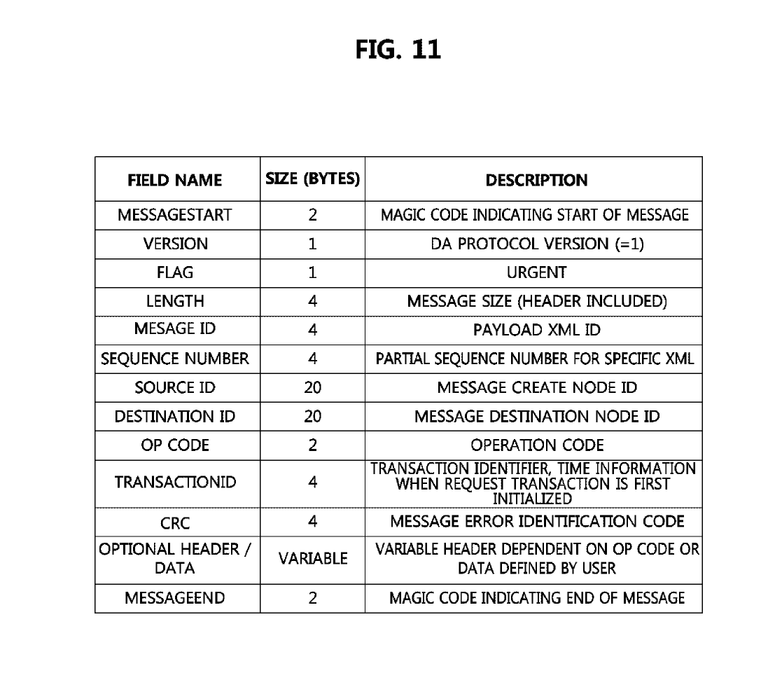

A message structure for providing various functions will be described hereinafter. The message structure explained with reference to FIG. 10 to FIG. 11 may be used for an initial configuration of the apparatus according to embodiments of the inventive concept explained with reference to FIG. 3 to FIG. 8.

FIG. 10 illustrates a message structure used in an initial configuration method according to an embodiment of the inventive concept. FIG. 10 illustrates a message structure used in the initial configuration process of the apparatus (i.e., a network interface setting, apparatus registration, service registration).

Referring to FIG. 10, the message structure used for the initial configuration of the apparatus may largely include a header 1010 and a payload 1020. Here, the header 1010 may be composed of a binary stream, and the payload 1020 may be composed in Extensible Markup Language (XML).

The header 1010 may include a start signal, an identifier of a source apparatus, an identifier of a destination apparatus, an operational code (OP code), an end signal, etc. Here, the OP code may include information for functions for the initial configuration of the apparatus as described hereinafter.

On the other hand, the payload 1020 may include substantial information for the initial configuration of the apparatus.

According to use of the message structure as shown in FIG. 10, the message manager of the apparatus receiving the message may analyze the header of the received message, and transmit the payload of the message to a corresponding function manager module of the function manager according to content that the OP code included in the header instructs. The corresponding function manager module receiving the payload may process the payload.

FIG. 11 illustrates a header format in the message structure of FIG. 10 in detail.

Referring to FIG. 11, the message header may include a message start field, a version field, a flag field, a length field, a message ID field, a sequence number field, a source ID field, a destination ID field, an OP code field, a transaction ID field, a cyclic redundancy code (CRC) field, an optional header/data field, and a message end field.

The message start (MessageStart) field may be composed of two bytes, and indicate a start of a message.

The version (Version) field may be composed of one byte, and illustrate a protocol version of an apparatus structure.

The flag (Flag) field may be composed of one byte, and indicate an urgent state of the message.

The length (Length) field may be composed of four bytes, and illustrate an entire size of the message including the header.

The message ID field may be composed of four bytes, and illustrate an XML ID of the payload.

The sequence number field may be composed of four bytes, and illustrate a partial sequence number for a specific XML of the payload.

The source ID field may be composed of twenty bytes, and illustrate an ID of a node (or an apparatus) generating a message.

The destination ID field may be composed of twenty bytes, and illustrate an ID of a destination node to which a message is transmitted.

The OP code field may be composed of two bytes, and illustrate information for processed functions.

The transaction ID field may be composed of four bytes, and illustrate time information when a transaction identifier and/or request transaction is first initiated.

The CRC field may be composed of four bytes, and include a code for identifying an error of the message.

The optional header/data (Optional Header/DATA) field may be composed of a variable number of bytes, and include a variable header dependent on the OP code and data defined by a user.

The message end (MessageEnd) field may be composed of two bytes, and indicate an end of the message.

Functions performed based on the message as shown in FIG. 10 and FIG. 11 may be defined by the OP code included in the header of the message. Main functions defined by the OP code may include functions for a zero configuration and remote maintenance of the apparatus such as a status information provision, a zero configuration, a remote diagnostic, healing, etc. of an apparatus.

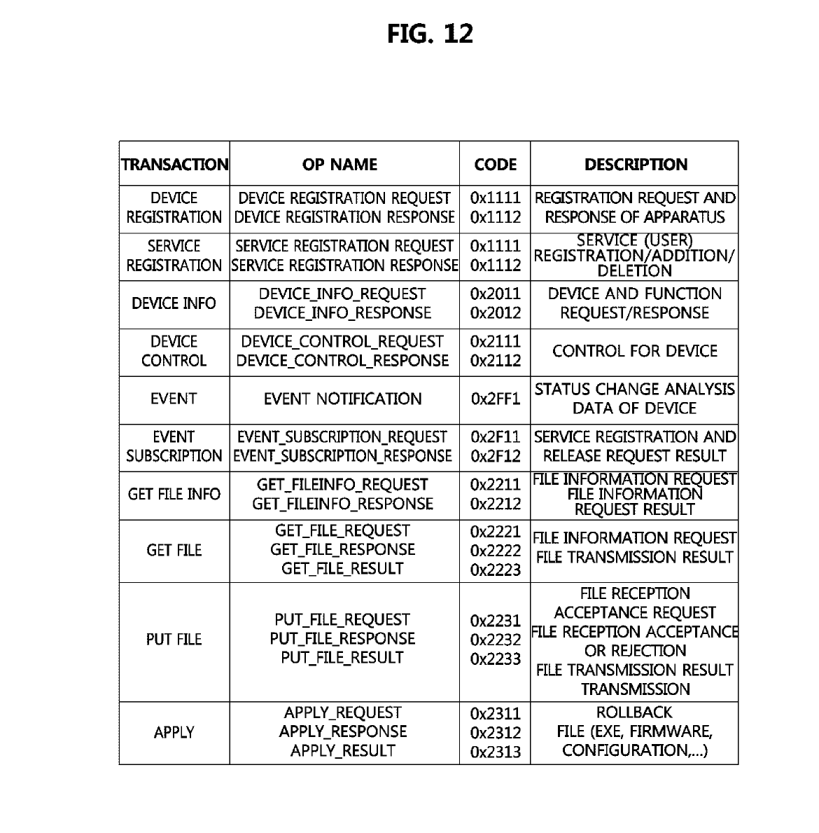

FIG. 12 illustrates detailed content of an operational code of FIG. 11.

Referring to FIG. 12, the operational code may define apparatus registration, service registration, apparatus information, apparatus control, an event process, an event subscription, a file-related transaction, and so on, and each operational code may have an operation name (OP name) and an intrinsic code corresponding to a defined transaction.

Specifically, the operational code may define a transaction related to device registration such as a device registration request or a device registration response.

Further, the operational code may define a transaction related to service (or user) registration such as registration, addition, deletion, etc. of a service.

The operational code may define a transaction related to a request or a response of device information or/and function information.

The operational code may define a transaction related to device control such as a device control request or a response to the device control request, etc.

The operational code may define a transaction related to an event such as notification of status change of a device or notification of data sensed by a sensor.

The operational code may define a transaction related to various event subscriptions such as a service registration request, a service release request, and a request result notification.

The operational code may define a transaction related to file information acquisition (GET FILE INFO) such as a file information request or response, etc., and a transaction related to file reception (GET FILE) such as file transmission request/response/file reception result transmission, etc. The operational code may define a transaction related to a file transmission (PUT FILE) such as file reception acceptance request/response/file transmission result transmission, etc.

The operational code may define a transaction such as application request/response/result etc. of a specific function (for example, a rollback, a file execution (FILE EXE), firmware, a configuration, etc.).

The operational codes shown in FIG. 11 may be a portion of various operational codes as an example, and operational codes used in the inventive concept are not limited to the operational codes shown in FIG. 11. For example, a portion of the operational codes shown in FIG. 11 may be selectively used in the inventive concept, or operational codes not shown in FIG. 11 may used by defining them according to the method shown in FIG. 11.

According to the initial configuration method of the apparatus and the apparatus including the initial configuration function, if the user installs an application for the initial configuration of the apparatus using short-distance wireless communication or a QR code in a smart phone, the application installed in the smart phone may automatically perform a network setting for registration of the apparatus to connect to a network, and automatically request the registration of the apparatus to a corresponding management server. Further, after completing the registration of the apparatus, the application may complete service (or user) registration by automatically requesting the service (or user) registration using the smart phone to the management server.

Accordingly, the initial configuration of the apparatus may be performed without user intervention. Therefore, users who do not have sufficient knowledge related to the initial configuration of the apparatus may easily complete the initial configuration of the apparatus.

Further, users who do not have sufficient knowledge related to the initial configuration and operation of the apparatus may easily perform the initial configuration of the apparatus and use an apparatus-associated service, and thus a user class of the apparatus can be expanded to various user classes due to convenience.

Moreover, according to expansion of manufactures and sales of apparatuses for various user classes, commercialization of the smart home appliances may progress.

Also, an environment in which manufacturers manufacturing apparatuses develop various apparatuses and apparatus-related services may be promoted.

While the example embodiments of the present invention and their advantages have been described in detail, it should be understood that various changes, substitutions and alterations may be made herein without departing from the scope of the invention.

What is claimed is:

1. An initial configuration method of an apparatus performed in the apparatus, the method comprising:
performing a setting for connecting the apparatus to a network based on information provided from a terminal in which a communication channel with the apparatus is formed; and
connecting the apparatus to the network and performing a process of registering the apparatus to a management server connected to the network.

2. The method of claim 1, further comprising, before the performing of the setting for connecting the apparatus to the network:
forming an exclusive communication channel with the terminal;
receiving a message instructing the setting of the apparatus from the terminal via the exclusive communication channel; and
transmitting an application for configuration of the apparatus to the terminal in response to the received message.

3. The method of claim 1, wherein the performing of the setting for connecting the apparatus to the network comprises performing the setting for connecting the apparatus to an Internet protocol (IP)-based network.

4. The method of claim 1, wherein the performing of the setting for connecting the apparatus to the network comprises:
receiving network setting information for connecting the apparatus to an access point or a network sharing device in a home from the terminal; and
performing the setting for connecting the network using the network setting information.

5. The method of claim 1, further comprising, before the connecting of the apparatus to the network and performing of the process of registering the apparatus to a management server connected to the network:
releasing the communication channel formed between the apparatus and the terminal

6. The method of claim 1, wherein the connecting of the apparatus to the network and performing of the process of registering the apparatus to a management server connected to the network comprises:
transmitting a message instructing apparatus registration to the management server via the network;
receiving a message indicating completion of the apparatus registration from the management server; and
transmitting the message indicating the completion of the apparatus registration to the terminal.

7. The method of claim 6, wherein the connecting of the apparatus to the network and performing of the process of registering the apparatus to a management server connected to the network comprises:
connecting the apparatus to an access point or a network sharing device;
connecting the apparatus to the access point or the network routing apparatus and connecting to the Internet; and
connecting the apparatus to the management server connected to the Internet.

8. The method of claim 7, wherein the transmitting of the message indicating the completion of the apparatus registration to the terminal comprises transmitting the message indicating the completion of the apparatus registration via the access point or the network sharing device.

9. The method of claim 1, wherein the initial configuration method of the apparatus includes communicating predefined messages with the terminal and the management server in the performing of the setting for connecting the apparatus to the network and the performing of the process of registering the apparatus, and
the message includes a header including an operational code indicating a function for the initial configuration of the apparatus, and a payload including information for the initial configuration of the apparatus.

10. The method of claim 9, wherein the operational code instructs at least one function among device registration, service registration, apparatus control, an event process, an event subscription, and a file transaction.

11. An initial configuration method of an apparatus in a terminal, the method comprising:
transmitting information for registration of the apparatus to the apparatus using a communication channel formed between the terminal and the apparatus;
receiving a message indicating that the apparatus is registered to a management server from the apparatus; and
transmitting a message requesting service registration to the management server.

12. The method of claim 11, further comprising, before the transmitting of the information for the registration of the apparatus to the apparatus:
forming an exclusive communication channel with the terminal;
transmitting a message instructing the initial configuration of the apparatus via the exclusive communication channel to the apparatus;
receiving an application for controlling the initial configuration of the apparatus from the apparatus;
executing the received application; and
performing a process for transmitting the information for the initial registration of the apparatus to the apparatus by the executed application.

13. The method of claim 11, further comprising, before the transmitting of the information for the registration of the apparatus to the apparatus:
connecting to the management server based on information obtained by photographing a code displayed on the apparatus;
downloading an application for controlling the initial configuration of the apparatus from the management server, and executing the downloaded application; and
transmitting the information of the initial configuration of the apparatus to the apparatus using the communication channel formed between the terminal and the apparatus by the executed application.

14. An apparatus, comprising:
a network interface configured to support an Internet protocol (IP)-based network connection and short-distance wireless communication;
a message manager configured to analyze a received message via the network interface, transmit a message based on the analyzed result, and create a message corresponding to a provided instruction; and
a function manager configured to perform a process for an initial configuration in response to a message provided from the message manager, or provide an instruction for the initial configuration.

15. The apparatus of claim 14, wherein the message manager creates a message including a header and a payload, and the header includes an operational code including instruction information for the initial configuration of the apparatus.

16. The apparatus of claim 15, wherein the operational code instructs at least one function among device registration, service registration, apparatus control, an event process, an event subscription, and a file transaction.

17. The apparatus of claim 14, wherein the function manager comprises:
a manager module configured to perform a control related to the initial configuration of the apparatus;
a file manager module configured to manage a file related to the initial configuration of the apparatus;
a configuration manager configured to perform a process for creating the communication channel between the network interface and other apparatuses; and
a registration manager configured to perform registration of the apparatus.
